(19) United States
(12) Patent Application Publication
(10) Pub. No.: US 2008/0100913 A1
(43) Pub. Date: May 1, 2008

(54) Polarization separating film and illumination apparatus for display device using the polarization separating film

(75) Inventors: Seong-mo Hwang, Yongin-si (KR); Dong-ho Wee, Yongin-si (KR); Seung-ho Nam, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/785,342

(22) Filed: Apr. 17, 2007

(30) Foreign Application Priority Data
Nov. 1, 2006 (KR) 10-2006-0107488

(51) Int. Cl. G02B 5/30

(52) U.S. Cl. 359/483

(57) ABSTRACT

A polarization separating film is provided, including an isotropic layer having a refractive index which is the same with respect to light having a first polarization and with respect to light having a second polarization, perpendicular to the first polarization; an anisotropic layer disposed on an upper surface of the isotropic layer and having a first refractive index with respect to light having the first polarization and a second refractive index, different from the first refractive index, with respect to light having the second polarization; a first micropattern disposed on a lower surface of the isotropic layer which changes an optical path of incident light; and a second micropattern, disposed on an interface between the isotropic layer and the anisotropic layer, which totally reflects light having the first polarization and which transmits light having the second polarization.

### CROSS-REFERENCE TO RELATED PATENT APPLICATIONS

This application claims priority from Korean Patent Application No. 10-2006-0107488, filed on Nov. 1, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a polarization separating film and an illumination apparatus for a display device using the polarization separating film, and more particularly, to a polarization separating film capable of transmitting only light in a particular polarization direction from light emitted from a light guide plate and simultaneously guiding the light emitted from the light guide plate along a normal direction, and an illumination apparatus for a display device using the polarization separating film.

2. Description of the Related Art

Display devices are classified as emissive types which form an image by emitting light or as non-emissive types which form an image by receiving light from the outside. For example, a liquid crystal display device is a non-emissive type of display device and thus, needs an illumination apparatus such as a backlight which functions as a separate light source. However, conventional liquid crystal display devices use about 5% of the total light emitted from the light source to form an image. Such low light use efficiency results from light absorption by an absorption type polarization plate and a color filter used in liquid crystal display devices. In particular, since an absorption type polarization plate is arranged on both surfaces of the liquid crystal display device, the absorption type polarization plates absorb about 50% of non-polarized incident light, and thus such arrangement is the main for the low light use efficiency of the liquid crystal display device.

To improve the light use efficiency of the liquid crystal display device, an illumination apparatus which provides only light having a polarization direction that is the same as the polarization direction of a rear polarization plate arranged on the rear surface of the liquid crystal display device has been suggested.

FIG. 1 illustrates the structure of a related art illumination apparatus for a display device. Referring to FIG. 1, the conventional illumination apparatus 10 includes a wedge type light guide plate 11, in the form of a wedge having an inclined lower surface; a light source 12, arranged at a side of the wedge light guide plate 11; a polarization separating film 13, arranged to face an upper surface of the light guide plate 11, a polarization conversion unit 15, arranged on the inclined lower surface of the light guide plate 11; and a light turning unit 14, arranged to face an upper surface of the polarization separating film 13.

In the related art illumination apparatus 10 configured as described above, the light emitted from the light source 12 is incident on an incident surface 11a of the light guide plate 11 and proceeds into the light guide plate 11. The light is totally reflected by the upper and lower surfaces of the light guide plate 11 and proceeds toward an end portion 11b of the light guide plate 11. In doing so, since a plurality of fine particles (not shown), having a refractive index different from that of the light guide plate 11, are distributed in the light guide plate 11, part of the light is refracted to be output through the upper surface of the light guide plate 11. The light output through the upper surface of the light guide plate 11 is incident on the polarization separating film 13. The polarization separating film 13 transmits the light polarized in the first direction and reflects the light polarized in the second direction which is orthogonal to the first direction. The reflected light from the polarization separating film 13 is incident again on the light guide plate 11 and reflected by the polarization conversion unit 15 that is on the lower surface of the light guide plate 11 such that the polarization direction is changed to an orthogonal direction. As a result, the light reflected by the polarization conversion unit 15 can be transmitted to the polarization separating film 13.

Thus, according to the related art illumination apparatus 10 illustrated in FIG. 1, little of the light emitted from the light source 12 is lost. Rather the light is converted into light having a polarization in a particular direction so as to be provided to the display device.

However, as illustrated in the graph of FIG. 2, for the related art illumination apparatus 10 for a display device illustrated in FIG. 1, most of the light exiting proceeds in an inclined direction. In detail, FIG. 2 illustrates the angular distribution of the light exiting the illumination apparatus, and shows that the maximum brightness of the exiting light is located in the vicinity of about −75° and most of the exiting light has an altitude angle of −50° or more. In the graph, a degree of 0° signifies a direction perpendicular to the upper surface of the light guide plate 11, a (+) sign signifies that the exiting light is directed towards the light source 12 in the light guide plate 11, and a (−) sign signifies that the exiting light is directed away from the light source 12 in the light guide plate 11. Thus, in the related art illumination apparatus 10, most of the light exiting the illumination apparatus proceeds away from the light source. To overcome the problem, as illustrated in FIG. 1, the light turning unit 14 having a reverse prism shape is additionally arranged on the upper surface of the polarization separating film 13.

Also, in the related art illumination apparatus 10 for a display device, a reflection type polarization plate or multilayer thin film such as a dual brightness enhancement film can be used as a related art polarization separating film. However, the related art polarization separating film is manufactured by depositing, stacking, and elongating hundreds layers of polymers or by forming of a film coated in a thin film multilayer through vacuum deposition, and such manufacturing processes are complicated and costly. Therefore, the related art illumination apparatus 10 of FIG. 1 incurs high manufacturing costs and is limited in terms of light use efficiency.

### SUMMARY OF THE INVENTION

Exemplary embodiments of the present invention provide a polarization separating film that can produce a polarized light along the normal direction with a simple structure and at low costs.

Exemplary embodiments of the present invention further provide an illumination apparatus for a display device having an improved light use efficiency using the polarization separating film.

According to an aspect of the present invention, a polarization separating film comprises an isotropic layer having a first refractive index with respect to light having a first polarization and with respect to light having a second polarization, perpendicular to the first polarization; an anisotropic layer disposed on an upper surface of the isotropic layer and having a first refractive index with respect to light having the first polarization and a second refractive index, different from the first refractive index, with respect to light having the second polarization; a first micropattern disposed on a lower surface of the isotropic layer which changes an optical path of incident light; and a second micropattern, disposed on an interface interface between the isotropic layer and the anisotropic layer, which totally reflects light having the first polarization and which transmits light having the second polarization.

The first refractive index of the anisotropic layer is greater than the refractive index of the isotropic layer, and the second refractive index of the anisotropic layer is the same as the refractive index of the isotropic layer.

The first and second micropatterns may each comprise an array of a plurality of microprisms.

An apex angle of a prism of the first micropattern may be greater than that of a prism of the second micropattern.

According to another aspect of the present invention, an illumination apparatus for a display device comprises a light source which emits light; a light guide plate having an incident surface on which the light emitted from the light source is incident, an opposite surface arranged to face the incident surface, and an upper surface from which the light is output; and the above-described polarization separating film arranged to face the upper surface of the light guide plate.

The light guide plate may be a wedge type light guide place having a lower surface that is inclined such that the thickness of the light guide plate decreases from the incident surface toward the opposite surface.

A scattering pattern may be disposed on the upper surface of the light guide plate.

The light guide plate may be an isotropic light guide plate having a refractive index which is the same with respect to light having the first polarization and with respect to light having the second polarization.

A polarization conversion member may be arranged on the lower surface of the light guide plate.

The polarization conversion member may be a ¼ wave plate.

The polarization conversion member may comprise an anisotropic polymer film or a photocurable liquid crystal polymer layer.

### BRIEF DESCRIPTION OF THE DRAWINGS

The above and other exemplary aspects and advantages of the present invention will become more apparent by the following detailed description of exemplary embodiments thereof with reference to the attached drawings in which:

FIG. 1 illustrates a structure of a related art illumination apparatus for a display device using a polarization separating film;

FIG. 2 is a graph illustrating the angular distribution of light output from a wedge type light guide plate of the related art illumination apparatus of FIG. 1;

FIG. 3 illustrates a structure of a polarization separating film according to an exemplary embodiment of the present invention and an illumination apparatus for a display device using the polarization separating film, according to an exemplary embodiment of the present invention;

FIG. 4 illustrates in detail a proceeding path of P-polarized light incident on the polarization separating film of FIG. 3, according to an exemplary embodiment of the present invention;

FIG. 5 illustrates in detail a proceeding path of S-polarized light incident on the polarization separating film of FIG. 3, according to an exemplary embodiment of the present invention; and

FIG. 6 illustrates a structure of a polarization separating film and an illumination apparatus for a display device using the polarization separating film, according to another exemplary embodiment of the present invention.

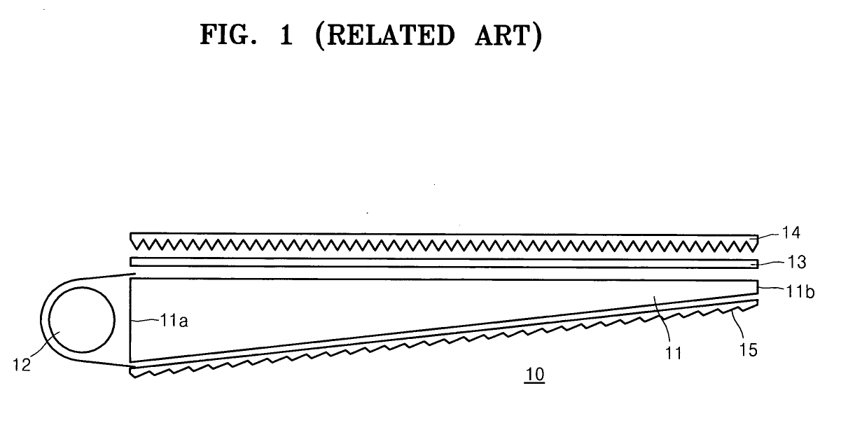

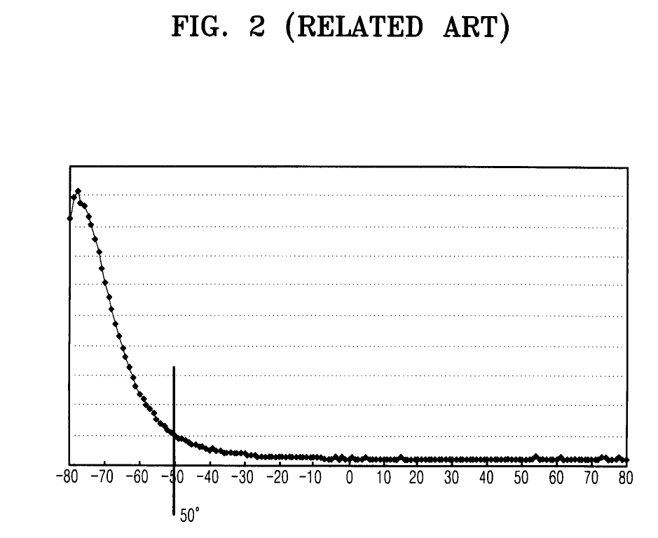

### DETAILED DESCRIPTION OF EXEMPLARY EMBODIMENTS OF THE INVENTION

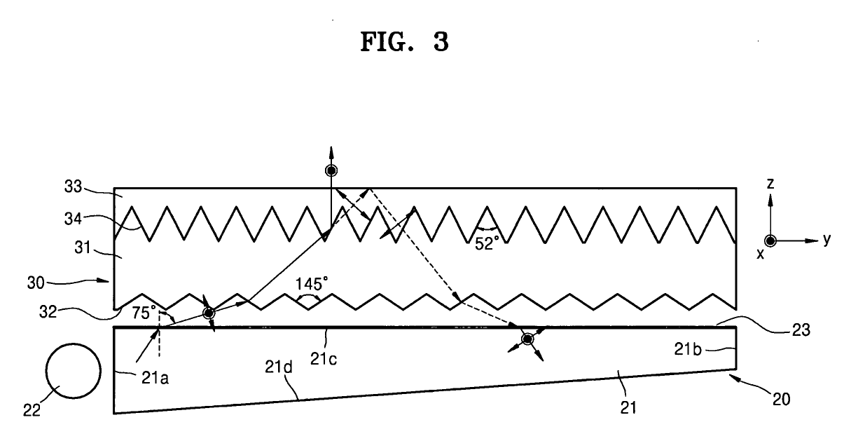

FIG. 3 illustrates a structure of a polarization separating film 30 according to an exemplary embodiment of the present invention and an illumination apparatus 20 for a display device using the polarization separating film 30, according to an exemplary embodiment of the present invention. Referring to FIG. 3, the illumination apparatus 20 for a display device includes a light source 22 emitting light; a light guide plate 21, having an incident surface 21a on which the light emitted from the light source 22 is incident, an opposite surface 21b facing the incident light surface 21a, and an upper surface 21c from which light exits; and the polarization separating film 30, arranged to face the upper surface 21c of the light guide plate 21.

According to an exemplary embodiment, the light guide plate 21 is a wedge type light guide plate and has a lower surface 21d inclined such that the thickness of the light guide plate 21 decreases from the incident surface 21a toward the opposite surface 21b. In the present embodiment, the light emitted from the light source 22 and input into the light guide plate 21 through the incident surface 21a is totally reflected at the upper and lower surfaces 21c and 21d and proceeds toward the opposite surface 21b of the light guide plate 21. Since the lower surface 21d of the light guide plate 21 is an inclined surface, part of the light which is totally reflected at the lower surface 21d does not satisfy a total reflection condition at the upper surface 21c and can exit through the upper surface 21c of the light guide plate 21. To assist the exit of the light, as in the related art technology, a plurality of fine particles (not shown), having a refractive index different from that of the light guide plate 21, are distributed inside the light guide plate 21. Also, as indicated by a thick line illustrated in FIG. 3, a fine scattering pattern 23 is formed on the upper surface 21c of the light guide plate 21. The scattering pattern 23 assists part of the light incident on the upper surface 21c of the light guide plate 21 to exit to the outside. Also, as described later, the scattering pattern 23 scatters the light input into the light guide plate 21 from the outside through the upper surface 21c of the light guide plate 21 to convert the polarized light into non-polarized light. The light guide plate 21 can be formed of an isotropic material having the same refractive index with respect to two perpendicular polarization components of light. For example, a material having a high light transmissivity characteristic such as poly methyl meth acrylate (PMMA) or poly carbonate (PC) can be used for the light guide plate 21.

A point light source, such as a light emitting diode (LED) or a laser diode (LD), or a linear light source, such as a cold cathode fluorescent lamp (CCFL), can be used as the light source 22.

As illustrated in FIG. 3, the polarization separating film 30 according to the present embodiment includes an isotropic layer 31, having the same refractive index with respect two perpendicular polarization components, and an anisotropic layer 33 formed on an upper surface of the isotropic layer 31 and having different refractive indices with respect to the two perpendicular polarization components. For example, when non-polarized light has a P-polarization component (indicated by [symbol] in the Figure) and an S-polarization component (indicated by “⊙ ” in the Figure), the refractive index of the anisotropic layer 33 with respect to the S-polarized light is greater than the refractive index of the isotropic layer 31, and the refractive index of the anisotropic layer 33 with respect to the P-polarized light is substantially the same as that of the isotropic layer 31. In contrast, a material which has a refractive index greater than that of the isotropic layer 31 with respect to the P-polarized light and a refractive index substantially the same as that of the isotropic layer 31 with respect to the S-polarized light can be used for the anisotropic layer 33. The same refractive index does not necessarily mean that the values of the refractive indexes are exactly the same. Even if there is a slight difference in the refractive indexes, the difference in refractive indices is acceptable if the refractive indices do not have a practical influence on the proceeding path of the light.

In the drawings, the thickness of the polarization separating film 30 is exaggerated for convenience of explanation. Actually, the isotropic layer 31 and the anisotropic layer 33 can be formed of a thin film as thin as 50-100 μm. For example, for the anisotropic layer 33, a polymer material such as poly ethylene naphthalate (PEN) or poly ethylene terephthalate (PET) can be used by elongating the polymer material in one direction, or a liquid crystal polymer that is formed by photocuring nematic liquid crystal can be used for the anisotropic layer 33. Also, another polymer material such as syndiotactic polystylene (PS) can be used for the anisotripic layer 33 by elongating the polymer material in one direction, or a liquid crystal polymer formed by photocuring discotic liquid crystal can be used for the anisotropic layer 33. For the isotropic later 31, a polymer material exhibiting high light transmissivity such as poly methyl meth acrylate (PMMA) or poly carbonate (PC) that is the same as the material used for the light guide plate 21, or a photocuring resin capable of being cured by ultraviolet (UV) rays, can be used.

A first micropattern 32, for changing the optical path of incident light, is formed on a lower surface of the isotropic layer 31 facing the upper surface 21c of the light guide plate 21. A second micropattern 34, for splitting light having two perpendicular polarization components, for example, a P-polarized component and an S-polarized component, is formed on an interface between the isotropic layer 31 and the anisotropic layer 33. For example, the first and second micropatterns 32 and 34 can be formed of a microprism array in a triangular shape. The micropatterns 32 and 34 can be easily and simply manufactured through an embossing method or a method of pressing the polarization separating film 30, using a stamp on which a micropattern is previously formed, and UV-curing the pressed polarization separating film 30.

In the operation of the polarization separating film 30 and the illumination apparatus 20 configured as above according to the present embodiment, first, the light emitted from the light source 22 is incident on the incident surface 21a of the light guide plate 21 and proceeds into the light guide plate 21. The light is totally reflected at the upper surface 21c and the lower surface 21d of the light guide plate 21 and proceeds toward the opposite surface 21b of the light guide plate 21. As described above, since the lower surface 21d of the light guide plate 21 is inclined such that the thickness of the light guide plate 21 gradually decreases toward the opposite surface 21b, part of the light which has been totally reflected by the lower surface 21d does not satisfy a total reflection condition at the upper surface and can therefore exit through the upper surface 21c of the light guide plate 21. Also, with the assistance of the fine particles (not shown) distributed in the light guide plate 21 and the scattering pattern 23 formed on the upper surface of the light guide plate 21, the light can be easily emitted through the upper surface of the light guide plate 21. As described above in relation to the related art technology, most of the light emitted through the upper surface of the light guide plate 21 has an altitude angle of about 50 degrees or more. In particular, most of the light output from the upper surface of the light guide plate 21 peaks at an altitude angle of about 75°.

The light emitted from the light guide plate 21 enters the isotropic layer 31 through the first micropattern 32 of the isotropic layer 31. The optical path of the light is refracted to be more vertical due to the first micropattern 32 of the isotropic layer 31. Then, the light enters the anisotropic layer 33 through the second micropattern 34 and is incident on the triangular shaped interface between the isotropic layer 31 and the anisotropic layer 33. The light at this point is non-polarized light having both S-polarization components and P-polarization components. The anisotropic layer 33 has different refractive indices with respect to the S-polarization component and the P-polarization component. For example, the refractive index of the anisotropic layer 33 is greater than the refractive index of the isotropic layer 31 with respect to the S-polarized light, and the refractive index of the anisotropic layer 33 is substantially the same as that of the isotropic layer 31 with respect to the P-polarized light. In this case, as shown in FIG. 3, the S-polarized light is totally reflected by the inclined surface of the second micropattern 34 and exits from the polarization separating film 30 along an almost normal direction. In contrast, the P-polarized light proceeds unchanged and is totally reflected at the interface between the upper surface of the anisotropic layer 33 and the outside air so as to be input into the light guide plate 21. In this process, the P-polarized light is converted into non-polarized light by the scattering pattern 23 on the upper surface 21c of the light guide plate 21. Then, the non-polarized light repeats the above-described process and finally becomes S-polarized light so that the light is output through the upper surface of the polarization separating film 30 along the normal direction.

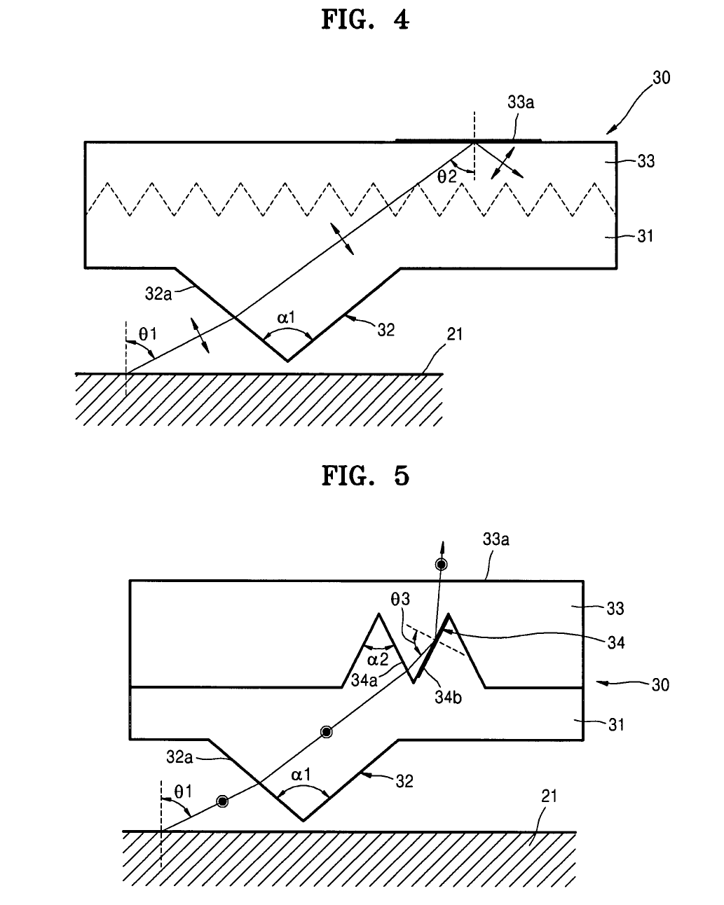

FIG. 4 illustrates in detail the proceeding path of the P-polarized light incident on the polarization separating film 30 of FIG. 3, according to an exemplary embodiment of the present invention. It is assumed that the refractive index of the anisotropic layer 33 is the same as the refractive index of the isotropic layer 31 with respect to P-polarized light. In this case, with respect to the P-polarized light, both the isotropic layer 31 and the anisotropic layer 33 are the same medium. Thus, in FIG. 4, the interface between the isotropic layer 31 and the anisotropic layer 33 is indicated by a dotted line.

First, as illustrated in FIG. 4, the P-polarized light output through the upper surface of the light guide plate 21 enters the isotropic layer 31 through an inclined surface 32a at a side of the first micropattern 32. The P-polarized light is slightly refracted in the normal direction. Then, the P-polarized light passes through the interface between the isotropic layer 31 and the anisotropic layer 33 without refraction and is obliquely incident on an interface 33a between the upper surface of the anisotropic layer 33 and the outside air. It is assumed that the refractive indices of the isotropic layer 31 and the anisotropic layer 33 with respect to the P-polarized light are both about 1.6 and that the first micropattern 32 formed on the lower surface of the isotropic layer 31 is the microprism array having a triangle shape whose apex angle α1 is about 145°. In the present embodiment, when an altitude angle θ1 of the P-polarized light output from the light guide plate 21 is about 55-90°, an incident angle θ2 of the P-polarized light incident on the interface 33a between the upper surface of the anisotropic layer 33 and the outside air is about 39.9-54.1°. Then, the P-polarized light is totally reflected on the interface between the upper surface of the anisotropic layer 33 and the outside air since the total reflection condition is satisfied. Thus, the P-polarized light does not pass through the polarization separating film 30, but rather proceeds back to the light guide plate 21.

FIG. 5 illustrates in detail the proceeding path of the S-polarized light incident on the polarization separating film 30 of FIG. 3, according to an exemplary embodiment of the present invention. It is assumed that the refractive index of the anisotropic layer 33 is greater than that of the isotropic layer 31 with respect to the S-polarized light. In this case, with respect to the S-polarized light, the isotropic layer 31 and the anisotropic layer 33 are different media.

First, as illustrated in FIG. 5, the S-polarized light output through the upper surface of the light guide plate 21, at the same altitude angle θ1 of about 55-90° as that of the P-polarized light, enters the isotropic layer 31 through the inclined surface 32a at a side of the first micropattern 32. The S-polarized light is slightly refracted in the normal direction. Then, the S-polarized light enters the anisotropic layer 33 through a surface 34a at a side of the second micropattern 34 formed on the interface between the isotropic, layer 31 and the anisotropic layer 33. In this step, the S-polarized light is slightly refracted again in the normal direction and then is obliquely incident on an inclined surface 34b of the second micropattern 34. It is assumed that the refractive index of the anisotropic layer 33 with respect to the S-polarized light is about 1.84 and the refractive index of the isotropic layer 31 is about 1.6. Also, it is assumed that the first micropattern 32 of the isotropic layer 31 is the microprism array having a triangle shape whose apex angle α1 is about 145°. Also, it is assumed that the second micropattern 34 is a microprism array having a triangle shape whose apex angle α2 is about 52°. In the present embodiment, most of the S-polarized light is incident on the inclined surface 34b of the second micropattern 34 at an incident angle θ3 of about 60-70°. Thus, the S-polarized light is totally reflected at the inclined surface 34b of the second micropattern 34 and exits from the polarization separating film 30 at an angle close to a right angle with respect to the upper surface of the anisotropic layer 33.

Thus, for the polarization separating film 30 according to the present embodiment, an additional unit for directing the optical path toward the normal direction is not needed. Part of the S-polarized light is not incident on the inclined surface 34b of the second micropattern 34 and can be incident on the interface 33a between the upper surface of the anisotropic layer 33 and the outside air. In the present embodiment, like the P-polarized light, the S-polarized light is totally reflected at the interface 33a between the upper surface of the anisotropic layer 33 and the outside air and reenters the light guide plate 21. Thus, it hardly occurs that light is output from the polarization separating film 30 a large altitude angle.

In the example described with reference to FIGS. 4 and 5, the apex angle α1 of the prism of the first micropattern 32 and the apex angle α2 of the prism of the second micropattern 34 may vary according to the refractive indices of the isotropic layer 31 and the anisotropic layer 33. However, in order for the S-polarized light to be totally reflected at the inclined surface 34b of the second micropattern 34, the apex angle α1 of the prism of the first micropattern 32 must be greater than the apex angle α2 of the prism of the second micropattern 34. Also, in FIGS. 4 and 5, the P-polarized light is totally reflected in order to be input into the light guide plate 21 and the S-polarized light is output from the polarization separating film 30 to the outside. However, when the refractive index of the anisotropic layer 33 with respect to the P-polarized light is greater than that of the isotropic layer 31 and the refractive index with respect to the S-polarized light is the same as that of the isotropic layer 31, the S-polarized light is totally reflected into the light guide plate 21 and the P-polarized light can be output from the polarization separating film 30 to the outside.

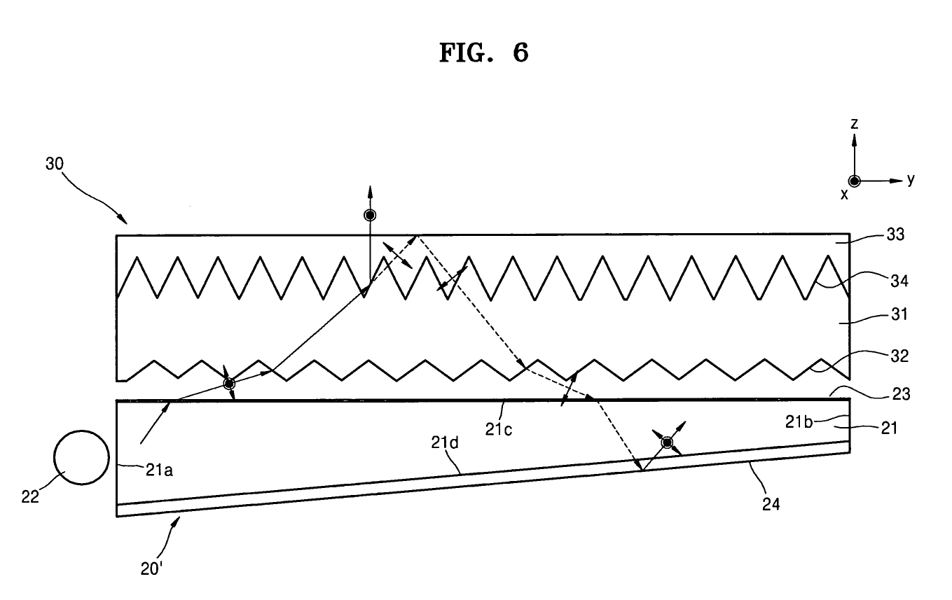

FIG. 6 illustrates a structure of an illumination apparatus 20′ for a display device according to another embodiment of the present invention. As compared to the illumination apparatus 20 of FIG. 3, the difference is that a polarization conversion member 24 is additionally arranged on the lower surface 21d of the light guide plate 21 in the illumination apparatus 20′ illustrated in FIG. 6. For the illumination apparatus 20 of FIG. 3, the P-polarized light or the S-polarized light totally reflected at the polarization separating film 30 is converted into non-polarized light through the scattering pattern 23 formed on the upper surface 21c of the light guide plate 21. However, since the amount of light that is changed to a non-polarized state by the scattering pattern 23 is relatively small, a considerable amount of light still remains in a polarized state. Thus, by attaching the polarization conversion member 24 on the lower surface 21d of the light guide plate 21, the polarization direction of the light reflected by the lower surface 21d of the light guide plate 21 can be efficiently converted. As the polarization conversion member 24, for example, a ¼ wave plate can be used. However, in addition to the ¼ wave plate, an anisotropic polymer film that is elongated or a photocurable liquid crystal polymer can be used as the polarization conversion member 24. For example, when the anisotropic polymer film having an optical axis rotated by 45° is used as the polarization conversion member 24 and arranged on the lower surface 21d of the light guide plate 21, the P-polarized light or S-polarized light reflected by the lower surface 21d of the light guide plate 21 can be converted into elliptically-polarized light or circularly-polarized light.

According to exemplary embodiments of the present invention, both functions of separating the polarization and directing the polarized light along the normal direction can be simultaneously performed by a simple structure. Thus, when the illumination device according to the present invention is used, the light use efficiency of a display device can be greatly increased.

Also, since the polarization separating film according to the exemplary embodiments of the present invention can be manufactured in a relatively simple process using an embossing method or an UV-curing method, the polarization separating film can be manufactured at quite low costs as compared to the conventional technology.

Although exemplary embodiments of the present invention have been described, it will be understood by those skilled in the art that the present invention should not be limited to the described embodiments, but that various changes and modifications can be made within the spirit and the scope of the present invention.

What is claimed is:

1. A polarization separating film comprising:
an isotropic layer having a refractive index which is the same with respect to light having a first polarization and with respect to light having a second polarization, perpendicular to the first polarization;
an anisotropic layer disposed on an upper surface of the isotropic layer and having a first refractive index with respect to light having the first polarization and a second refractive index, different from the first refractive index, with respect to light having the second polarization;
a first micropattern, disposed on a lower surface of the isotropic layer, which changes an optical path of incident light; and
a second micropattern, disposed on an interface between the isotropic layer and the anisotropic layer, which totally reflects light having the first polarization and which transmits light having the second polarization.

2. The polarization separating film of claim 1, wherein the first refractive index of the anisotropic layer is greater than the refractive index of the isotropic layer and the second refractive index of the anisotropic layer is the same as the refractive index of the isotropic layer.

3. The polarization separating film of claim 1, wherein the first and second micropatterns each comprise an array of a plurality of microprisms.

4. The polarization separating film of claim 3, wherein an apex angle of each of the microprisms of the first micropattern is greater than that of each of the microprisms of the second micropattern.

5. An illumination apparatus for a display device, the illumination apparatus comprising:
a light source which emits light;
a light guide plate having an incident surface on which the light emitted from the light source is incident, an opposite surface facing the incident surface of the light guide plate, and an upper surface from which the light is output; and
a polarization separating film facing the upper surface of the light guide plate,
wherein the polarization separating film comprises:
an isotropic layer having a refractive index which is the same with respect to light having a first polarization and with respect to light having a second polarization, perpendicular to the first polarization;
an anisotropic layer disposed on an upper surface of the isotropic layer and having a first refractive index with respect to light having the first polarization and a second refractive index, different from the first refractive index, with respect to light having the second polarization;
a first micropattern, disposed on a lower surface of the isotropic layer, which changes an optical path of incident light; and
a second micropattern, disposed on an interface between the isotropic layer and the anisotropic layer, which totally reflects light having the first polarization and which transmits light having the second polarization.

6. The illumination apparatus of claim 5, wherein the first refractive index of the anisotropic layer is greater than the refractive index of the isotropic layer, and the second refractive index of the anisotropic layer is the same as the refractive index of the isotropic layer.

7. The illumination apparatus of claim 5, wherein the first and second micropatterns each comprise an array of a plurality of microprisms.

8. The illumination apparatus of claim 7, wherein an apex angle of each of the microprisms of the first micropattern is greater than that of each of the microprisms of the second micropattern.

9. The illumination apparatus of claim 5, wherein the light guide plate is a wedge type light guide plate having a lower surface that is inclined such that a thickness of the light guide plate decreases from the incident surface of the light guide plate toward the opposite surface of the light guide plate.

10. The illumination apparatus of claim 5, further comprising a scattering pattern is disposed on the upper surface of the light guide plate.

11. The illumination apparatus of claim 5, wherein the light guide plate is an isotropic light guide plate having a refractive index which is the same with respect to light having the first polarization and with respect to light having the second polarization.

12. The illumination apparatus of claim 5, further comprising a polarization conversion member is disposed on the lower surface of the light guide plate.

13. The illumination apparatus of claim 12, wherein the polarization conversion member is a ¼ wave plate.

14. The illumination apparatus of claim 12, wherein the polarization conversion member comprises one of an anisotropic polymer film and a photocurable liquid crystal polymer layer.
